(19) United States
(12) Patent Application Publication
(10) Pub. No.: US 2023/0407210 A1
(43) Pub. Date: Dec. 21, 2023

(54) FLUORINE-BASED SOLVENT COMPOSITION

(71) Applicant: CHEMOURS-MITSUI FLUOROPRODUCTS CO., LTD., MINATO-KU, TOKYO (JP)

(72) Inventor: HIDEAKI KIKUCHI, SHIZUOKA (JP)

(73) Assignee: CHEMOURS-MITSUI FLUOROPRODUCTS CO., LTD., MINATO-KU, TOKYO, JP (JP)

(21) Appl. No.: 18/035,700

(22) PCT Filed: Nov. 29, 2021
(86) PCT No.: PCT/US2021/061005

§ 371 Date: May 5, 2023

(30) Foreign Application Priority Data
Nov. 30, 2020 (JP) 2020-198522

(51) Int. Cl. C11D 3/43; C11D 17/00; C11D 11/00; C10M 109/00

(52) U.S. Cl. CPC C11D 3/43; C11D 17/0043; C10N 2050/02; C10M 109/00; C11D 11/0023

(57) ABSTRACT

Disclosed are azeotropic compositions comprising a perfluoroheptene, and a chlorotrifluoropropene. Also disclosed herein are novel methods of using these compositions as novel solvents, degreasing or defluxing solvent, or carrier fluids.

### CROSS REFERENCE TO RELATED APPLICATIONS

This application is a national filing under 35 U.S.C. 371 of International Application No. PCT/US2021/061005 filed Nov. 29, 2021, and claims the benefit of priority of Japanese Patent Application No. JP2020-198522 filed Nov. 30, 2020, the disclosures of which are incorporated herein by reference in its entirety.

### TECHNICAL FIELD

The present invention relates to a fluorine-based solvent composition containing perfluoroheptene (PFH) and chlorotrifluoropropene.

### BACKGROUND TECHNOLOGY

In many industries, fluorine-based solvents including chlorofluorocarbons (CFC), hydrochlorofluorocarbons (HCFC), hydrofluorocarbons (HFC), and other halogenated hydrocarbons have been conventionally used in a wide range of applications including aerosol propellants, refrigerants, solvents, cleaning agents, foaming agents for thermoplastic and thermosetting foams, heating media, gaseous dielectric bodies, fire extinguishing agents and fire controlling agents, power cycle working fluids, polymerization media, fine particle removing fluids, carrier fluids, buffing compounds, substitution drying agents, and the like.

However, CFCs and HCFCs are known as ozone-depleting substances. In particular, HCFCs such as HCFC-225 have excellent nonflammability, polymer compatibility, stability, and the like and thus have been widely used. However, HCFCs have an ozone depletion potential and high global warming potential, and thus were completely abolished from 2019.

On the other hand, although HFCs do not pose a risk of depleting the ozone layer, HFCs do affect global warming as a greenhouse gas. Therefore, an alternative product is required, which has low environmental impact, in other words, an ozone depletion potential of 0 and a very low global warming potential.

Hydrochlorofluoroolefins (HCFOs), hydrofluoroolefins (HFOs), and periluoroolefins (PFOs) have been developed as alternative products. Of PFOs, periluoroheptene (PFH), where all hydrogens are replaced with fluorine, has an ozone depletion potential of 0 and a low global warming potential, and thus has been proposed for use in various applications. Furthermore, chlorotrifluoropropene is known as an HCFO, and is useful as a cleaning agent, solvent, and the like. However, in cleaning applications, HCFO has a high polymer dissolving ability (strong polymer attack properties (solubility)), and therefore cannot be used in products containing a polymer. Moreover, HFO and PFH have low oil solubility, and thus a cleaning effect is difficult to achieve.

Furthermore, it is known that azeotropic compositions with a constant boiling point property that are not fractionated during use or distillation during recovery, in other words, compositions that are not fractionated during boiling and evaporation, are useful. However predicting whether or not an azeotropic composition will be formed is theoretically impossible, resulting in continued search for new azeotropic compositions with excellent properties for various combinations.

### SUMMARY OF THE INVENTION

In order to solve the aforementioned problems, an object of the present invention is to provide a novel azeotrope-like composition that can be used in a wide range of industrial applications.

The present inventors discovered that a composition containing pertluoroheptene (PFH) with an ozone depletion potential of 0 and low global warming potential and chlorotrifluoropropene with excellent oil solubility is a composition with high safety, that is friendly to the global environment, has excellent polymer compatibility (where polymer attack properties (solubility) are suppressed), and forms an azeotrope-like composition that exhibits behavior like a single compound, thereby achieving the present invention.

In other words, the present invention is characterized by the following points.
1. A composition, containing: perfluoroheptene; and chlorotrifluoropropene.
2. An azeotropic or azeotropic-like composition containing perfluoroheptene and chlorotrifluoropropene.
3. The azeotrope-like composition according to 1. or 2., where the perfluoroheptene is at least one type selected from 1,1,1,2,2,3,4,5,5,6,6,7,7,7-tetradecafluoro-3-heptene, 1,1,1,2,3,4,4,5,5,6,6,7,7,7-tetradecafluoro-2-heptene, and isomers thereof.
4. The composition according to 1. or 2., where the chlorotrifluoropropene is at least one type selected from 1-chloro-2,3,3-trifluoropropene, 1-chloro-3,3,3-trifluoro-1-propene, and isomers thereof.
5. The composition according to any of 1 to 4, containing: 10.0 to weight % of perfluoroheptene; and 25.0 to 90.0 weight % of 1-chloro-2,3,3-trifluoro-1-propene.
6. The composition according to any of 1 to 5, containing: 20.0 to weight % of perfluoroheptene; and 25.0 to 80.0 weight % of 1-chloro-2,3,3-trifluoro-1-propene.
7. The composition according to any of 1 to 6, containing: 45.0 to weight % of perfluoroheptene; and 45.0 to 55.0 weight % of 1-chloro-2,3,3-trifluoro-1-propene.
8. The composition according to any of 1 to 4, containing: 5.0 to weight % of perfluoroheptene; and 70.0 to 95.0 weight % of 1-chloro-3,3,3-trifluoro-1-propene.
9. The composition according to any of 1 to 4 and 8, containing: to 20.0 weight % of perfluoroheptene; and 80.0 to 90.0 weight % of 1-chloro-3,3,3-trifluoro-1-propene.
10. A cleaning agent, containing the composition according to any of 1 to 9.
11. A method of cleaning an article using the cleaning agent according to 10.

According to the present invention, a composition can be provided, having an ozone depletion potential of 0 and a very low global warming potential.

The composition of the present invention is a composition containing perfluoroheptene (PFH) and chlorotrifluoropropene that has excellent oil solubility, and is a composition having high safety, that is friendly to the global environment, and has excellent polymer compatibility (where polymer attack properties (solubility) are suppressed). The present invention also has advantages of being an azeotrope-like composition exhibiting the same behavior as a single compound and is not flammable.

### BRIEF DESCRIPTION OF THE DRAWINGS

FIG. 1 shows a gas-liquid equilibrium curve of Example 1.

FIG. 2 shows a gas-liquid equilibrium curve of Example 2.

### DESCRIPTION OF THE PREFERRED EMBODIMENTS

The present invention will be described in detail hereinafter. The composition of the present invention essentially contains perfluoroheptene (PFH) and chlorotrifluoropropene, and both components together preferably account for 50% or more, more preferably 55% or more, and even more preferably 60% or more of the composition.

In the present invention, the PFH is not limited to a structural isomer/stereoisomer, and may be a single isomer or a mixture of isomers. Preferred examples include at least one type selected from 1,1,1,2,2,3,4,5,5,6,6,7,7,7-tetradecafluoro-3-heptene (perfluoro-3-heptene), 1,1,1,2,3,4,4,5,5,6,6,7,7,7-tetradecafluoro-2-heptene (perfluoro-2-heptene), and isomers thereof, more preferably cis-perfluoro-3-heptene, trans-perfluoro-3-heptene, and mixtures thereof, and particularly preferably trans-perfluoro-3-heptene and mixtures thereof.

Various isomers are present in chlorotrifluoropropene (HCFO-1233). The HCFO-1233 used in the present invention is preferably 1-chloro-2,3,3-trifluoropropene (HCFO-1233yd), 1-chloro-3,3,3-trifluoro-1-propene (HCFO-1233zd), or a mixture thereof. HCFO-1233yd is preferably cis-HCFO-1233yd or a mixture containing cis-HCFO-1233yd.

As recognized in the technical field, an azeotropic composition is a mixture of two or more different components which, when in a liquid form under a given pressure, boils at an essentially constant temperature. The temperature is higher or lower than the boiling temperature of the individual components. Moreover, the composition provides a vapor composition that is essentially identical to the overall composition during boiling (for example, refer to M. F. Doherty and M. F. Malone, Conceptual Design of Distillation Systems, McGraw-Hill (New York), 2001, pages 185-186, 351-359).

It is known that the boiling point of the azeotropic composition is at a maximum or minimum when measuring the gas-liquid equilibrium relationship at constant pressure by making various changes to the liquid composition within a range close to the composition of the azeotropic mixture at this time.

Therefore, an essential feature of an azeotropic composition is that at a given pressure, the boiling point of the liquid composition is fixed, and the composition of the vapor above the composition during boiling is essentially the composition of the overall liquid composition during boiling (in other words, no fractionation of the components of the liquid composition occurs). It is also recognized in this technical field that, when an azeotropic composition is boiled at different pressures, both the boiling point and the mass percentage of each component of the azeotropic composition may change. Therefore, an azeotropic composition may be defined from the perspective of a unique relationship that exists between the components, from the perspective of the compositional range of the components, or from the perspective of an exact mass percentage of each component of the composition characterized by a fixed boiling point at a specified pressure.

The composition of the present invention refers to a composition that behaves like an azeotropic composition (in other words, has constant boiling point properties or a tendency to not be fractionated when boiled or evaporated). Therefore, even if the gas-liquid composition were to change during boiling or evaporation, the change would be minimal or negligible. This is in contrast to a non-azeotrope-like composition in which the gas-liquid composition changes substantially during boiling or evaporation.

Furthermore, the composition of the present invention exhibits a liquid phase curve and a gas phase curve with essentially no temperature difference. In other words, the difference between the liquid phase temperature and the gas phase temperature at a given pressure would be a small value. In the present invention, a composition where the difference relative to the liquid phase temperature is 2° C. or less (based on the minimum azeotropic point) is considered to be an azeotrope-like composition.

Furthermore, it is well known in the field that when the relative volatility of a certain system approaches 1.0, the system is defined as forming an azeotropic composition or an azeotrope-like composition. The relative volatility is the ratio of the volatility of component 1 to the volatility of component 2. The ratio of the molar fraction of a component in a vapor to that in a liquid is the volatility of the component.

The azeotrope-like composition containing PFH and chlorotrifluoropropene of the present invention preferably has a boiling point at atmospheric pressure within a range of 30 to 100° C., and preferably 40 to 80° C.

In the present invention, when the chlorotrifluoropropene is 1-chloro-2,3,3,-trifluoropropene (HCFO-1233yd), the composition of the present invention preferably has a boiling point at atmospheric pressure of 49 to 51° C., and more preferably 49 to 50° C.

The added amount thereof is preferably PFH : HCFO-1233yd=10 to 75 weight %: 90 to 25 weight %, more preferably 20 to 75 weight % : 80 to 25 weight %, and even more preferably 45 to 55 weight % : 55 to 45 weight %. When the PFH is less than 10 weight % (in other words, when the amount of HCFO is higher than the PFH), polymer attack properties (solubility) may increase. Conversely, when the PFH exceeds 75 weight % (in other words, when the amount of HCFO is lower than the PFH), the oil removal rate may be reduced.

In the present invention, when the chlorotrifluoropropene is 1-chloro-3,3,3,-trifluoropropene (HCFO-1233zd), the composition of the present invention preferably has a boiling point at atmospheric pressure of 36 to 41° C., and more preferably 38.5 to 40.5° C. The added amount thereof is preferably PFH: HCFO-1233zd=5 to 30 weight % : 95 to 70 weight %, and more preferably 10 to 20 weight % : 90 to 80 weight %. When the PFH is less than 5 weight % (in other words, when the amount of HCFO is higher than that of PFH), the polymer attack properties (solubility) may increase. Conversely, when the amount of PFH exceeds weight % (in other words, when the amount of HCFO is lower than the PFH), the oil removal rate may be reduced.

The composition of the present invention preferably further contains an alcohol. The alcohol is at least one type selected from alcohols having 1 to 3 carbon atoms, and more preferably ethanol.

The composition of the present invention may contain one or more type of nitroalkanes, epoxides, furans, benzotriazoles, phenols, amines, or phosphates as stabilizers if necessary, and the added amount thereof is 0.01 to 5 weight %, and preferably 0.05 to 0.5 weight % with regard to the composition.

The composition of the present invention may also contain another component such an alcohol (other than alcohols having 1 to 3 carbon atoms), ketone, ether, ester, hydrocarbon, amine, glycol ether, and siloxane if necessary within a range that does not impair the characteristics of the present invention.

The composition of the present invention has an ozone depletion potential (ODP) of 0 and a global warming potential (GWP) of approximately 100 or less, preferably 50 or less, and more preferably 10 or less. Herein, the ODP and GWP in the present invention are defined in the World Meteorological Organization's report, “Scientific Assessment of Ozone Depletion, 2002”.

The composition of the present invention can be used in a wide range of applications in which halogenated hydrocarbons were conventionally used, such as aerosol propellants, refrigerants, solvents, cleaning agents, fine particle removing fluids, foaming agents for thermoplastic and thermosetting foams (foam expanding agents), heating media, gaseous dielectric bodies, fire extinguishing agents and fire controlling agents, power cycle working fluids, polymerization media, carrier fluids, buffing compounds, substitute drying agents, and the like.

Note that when the present invention is used as a cleaning agent, a subject to be cleaned by the composition of the present invention is not particularly limited, but the present invention can be suitably used in electronic, electric, and mechanical parts and the like, or small automotive parts and the like, which should be continuously produced and cleaned, and the like.

In one embodiment, the present method comprises contacting the article with a cleaning composition of the invention, in a vapor degreasing and solvent cleaning method. In one such embodiment, vapor degreasing and solvent cleaning methods consist of exposing an article, preferably at room temperature, to the vapors of a boiling cleaning composition. Vapors condensing on the object have the advantage of providing a relatively clean, distilled cleaning composition to wash away grease or other contamination. Such processes thus have an additional advantage in that final evaporation of the present cleaning composition from the object leaves behind relatively little residue as compared to the case where the object is simply washed in liquid cleaning composition.

Of these, the composition of the present invention can be suitably used as a cleaning agent for cleaning a solid surface having grime of an organic component (oil) or inorganic component, for example, semiconductor surfaces, electronic substrate surfaces, CMOS (Complementary Metal Oxide Semiconductor), MEMS (Micro Electro Mechanical Systems), hard disk surfaces, and other surfaces having a fine structure.

In particular, the composition of the present invention forms an azeotrope-like composition that has high oil solubility and excellent cleaning properties and that exhibits the same behavior as a single compound, in conjunction with having high safety, being friendly to the global environment, and having excellent polymer compatibility (where polymer attack properties (solubility) is suppressed). Therefore, the composition is suitable for cleaning resin products.

Furthermore, the composition of the present invention can be suitably used as a refrigerant for cooling. In particular, the composition exhibits azeotropy, and therefore, the composition is also suitable as a refrigerant for use in a cooling method (evaporation cooling) that includes a step of condensing the composition of the present invention and a step of evaporating near an object to be cooled.

Another embodiment relates to a method of depositing a fluorolubicant on a surface comprising: combining a fluorolubricant and a solvent, said solvent comprising the azeotropic compositions of perfluoroheptene (PFH) and chlorotrifluoropropene disclosed herein, to form a lubricant-solvent combination; contacting the combination of lubricant-solvent with the surface; and evaporating the solvent from the surface to form a fluorolubricant coating on the surface

The most advanced, highest recording densities and lowest cost method of storing digital information involves writing and reading magnetic flux patterns from rotating disks coated with magnetic materials. A magnetic layer, where information is stored in the form of bits, is sputtered onto a metallic support structure. Next an overcoat, usually a carbon-based material, is placed on top of the magnetic layer for protection and finally a lubricant is applied to the overcoat. A read-write head flies above the lubricant and the information is exchanged between the head and the magnetic layer. In a relentless attempt to increase the efficiency of information transfer, hard drive manufacturers have reduced the distance between the head and the magnetic layer, or fly-height, to less than 100 Angstroms.

Invariably, during normal disk drive application, the head and the disk surface will make contact. To reduce wear on the disk, from both sliding and flying contacts, it must be lubricated.

Fluorolubricants are widely used as lubricants in the magnetic disk drive industry to decrease the friction between the head and disk, that is, reduce the wear and therefore minimize the possibility of disk failure.

There is a need in the industry for improved methods for deposition of fluorolubricants. The use of certain solvents, such as CFC-113 and PFC-5060, has been regulated due to their impact on the environment. Therefore, solvents that will be used in this application should consider environmental impact. Also, such solvent must dissolve the fluorolubricant and form a substantially uniform or uniform coating of fluorolubricant. Additionally, existing solvents have been found to require higher fluorolubricant concentrations to produce a given thickness coating and produce irregularities in uniformity of the fluorolubricant coating.

In one embodiment, the fluorolubricants of the present disclosure comprise perfluoropolyether (PFPE) compounds, or lubricant comprising X-1P®, which is a phosphazene-containing disk lubricant. These perfluoropolyether compounds are sometimes referred to as perfluoroalkylethers (PFAE) or perfluoropolyalkylethers (PFPAE). These PFPE compounds range from simple perfluorinated ether polymers to functionalized perfluorinated ether polymers. PFPE compounds of different varieties that may be useful as fluorolubricant in the present invention are available from several sources. In another embodiment, useful fluorolubricants for the present inventive method include but are not limited to Krytox® GLP 100, GLP 105 or GLP 160 (E. I. du Pont de Nemours & Co., Fluoroproducts, Wilmington, DE, 19898, USA); Fomblin® Z-Dol 2000, 2500 or 4000, Z-Tetraol, or Fomblin® AM 2001 or AM 3001 (sold by Solvay Solexis S.p.A., Milan, Italy); Demnum™ LR-200 or S-65 (offered by Daikin America, Inc., Osaka, Japan); X-1P® (a partially fluorinated hyxaphenoxy cyclotriphosphazene disk lubricant available from Quixtor Technologies Corporation, a subsidiary of Dow Chemical Co, Midland, MI); and mixtures thereof. The Krytox® lubricants are perfluoroalkylpolyethers having the general structure F(CF(CF3)CF2O)n-CF2CF3, wherein n ranges from 10 to 60. The Fomblin® lubricants are functionalized perfluoropolyethers that range in molecular weight from 500 to 4000 atomic mass units and have general formula X-CF2-O(CF2-CF2-O)p-(CF2O)q-CF2-X, wherein X may be —CH2OH, CH2(O-CH2-CH2)nOH, CH2OCH2CH(OH)CH2OH or —CH2O-CH2-piperonyl. The Demnum™ oils are perfluoropolyether-based oils ranging in molecular weight from 2700 to 8400 atomic mass units. Additionally, new lubricants are being developed such as those from Moresco (Thailand) Co., Ltd, which may be useful in the present inventive method.

The surface on which the fluorolubricant may be deposited is any solid surface that may benefit from lubrication. Semiconductor materials such as silica disks, metal or metal oxide surfaces, vapor deposited carbon surfaces or glass surfaces are representative of the types of surfaces for which the methods of the present invention are useful. The present inventive method is particularly useful in coating magnetic media such as computer drive hard disks. In the manufacture of computer disks, the surface may be a glass, or aluminum substrate with layers of magnetic media that is also coated by vapor deposition with a thin (10-50 Angstrom) layer of amorphous hydrogenated or nitrogenated carbon. The fluorolubricant may be deposited on the surface disk indirectly by applying the fluorolubricant to the carbon layer of the disk.

The first step of combining the fluorolubricant and solvent may be accomplished in any suitable manner such as mixing in a suitable container such as a beaker or other container that may be used as a bath for the deposition method. The fluorolubricant concentration in the unsaturated fluorinated ether solvent may be from about 0.010 percent (wt/wt) to about 0.50 percent (wt/wt).

The step of contacting said combination of fluorolubricant and solvent with the surface may be accomplished in any manner appropriate for said surface (considering the size and shape of the surface).

Furthermore, the composition of the present invention can be suitably used as a foaming agent for manufacturing thermoplastic or thermosetting foams. The present invention is described below in detail based on examples.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified. If in the claim such would close the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

As used herein, the phrase “consisting essentially of” is intended to cover a partially exclusive inclusion. For example, a composition, method, process or apparatus that consists essentially of elements is not limited to only those elements, but may only include other elements that do not materially change the intended advantageous properties of the composition, method, process or apparatus.

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

### EXAMPLES

Measurements and calculations of the boiling point, surface tension, density, viscosity, and flash point of a mixture containing PFH and chlorotrifluoropropene, and an oil solubility test and resin compatibility test were performed by the following methods.

### Boiling Point (Equilibrium Reflux Boiling Point)

The boiling point (equilibrium reflux boiling point) was measured in accordance with JIS K 2233 with the exception that the cooling water temperature was set to 5° C., and that heating was performed directly without anything placed between the hot plate and the flask.

### Density: Amagat's Law

Vₘ=ΣxⱼVⱼ
V: Density
x: Molar fraction
Note that the density value of PFH was 1.63 g/mL (calculated using NIST REFPROP Ver. 10. 25° C. setting), the density of HCFO-1233 yd was 1.39 g/mL (cited from AGC Research Report 69 (2019), Development of Environmentally Friendly Fluorine-Based Solvent AMOLEA®AS-300), and the density of HCFO-1233zd was 1.31 g/mL (cited from Central Glass Co., Ltd., Next Generation Fluorine-Based Solvent with Excellent Environmental Performance and High Cleaning Power, October 2015).

The viscosity of the composition was calculated using the following equation.
Viscosity: McAllister method

InηₘΣxᵢf(ηᵢ)
η: Viscosity
x: Molar fraction
f(η): Log of viscosity
Note that the viscosity of the PFH was 0.77 mPa·s (calculated using NIST REFPROP Ver. 10. 25° C. setting), the viscosity of the HCFO-1233yd was mPas (cited from AGC Research Report 69 (2019), Development of Environmentally Friendly Fluorine-Based Solvent AMOLEA®AS-300), and the viscosity of the HCFO-1233zd was 0.41 mPa·s (cited from Central Glass Co., Ltd., Next Generation Fluorine-Based Solvent with Excellent Environmental Performance and High Cleaning Power, October 2015).

### Surface Tension

The surface tension of the composition was calculated using the following equation.
Surface tension: Macleod-Sugden correlation equation

σ^{1/4}=[P](ρ_{L}−ρ_{V})/MW
σ: Surface tension
P: Parachor constant
ρ_{L}: Liquid specific gravity
ρ_{V}: Vapor specific gravity
Mw: Molecular weight
Note that the surface tension value of PFH was 13.8 mN/m (calculated using NIST REFPROP Ver. 10. 25° C. setting), the surface tension of HCFO-1233yd was 21.7 mN/m (cited from AGC Research Report 69 (2019), Development of Environmentally Friendly Fluorine-Based Solvent AMOLEA®AS-300), and the surface tension of HCFO-1233zd was 18.6 mN/m (cited from Central Glass Co., Ltd., Next Generation Fluorine-Based Solvent with Excellent Environmental Performance and High Cleaning Power, October 2015).

### Flash Point

The flash point was measured by the Tag closed and Cleveland open flash point test in accordance with JIS K 2265-1980.

### Oil Dissolution Rate

In a 50 mL glass screw bottle, oil at an amount indicated in “Oil Mixture Amount” in Table 2 or Table 3 (expressed as weight % with regard to 20 g of the composition) to 20 g of any of the compositions of Examples 1 to 7 indicated in Table 1 were shaken by hand for 30 seconds at room temperature, and then left to stand. The appearance of the solution was then visually observed.
○: Uniform solution (no cloudiness or separation of two layers)
x: Cloudiness or separation of two layers

### Oil Removal Rate

The oil removal rate is used as an index indicating cleaning performance. The oil removal rate is calculated by the following equation.

$$Oil removal rate ( \% ) = \frac{\begin{matrix}( Amount of oil adhered to object \\ to be cleaned before cleaning - \\ Amount of oil adhered to object \\ to be cleaned after cleaning )\end{matrix}}{\begin{matrix}( Mass of oil adhered to object \\ to be cleaned before cleaning )\end{matrix}} \times 100$$

### Cleaning Conditions

The compositions shown in Table 1 were used as cleaning agents.

A desktop ultrasonic cleaning machine (3-frequency ultrasonic cleaning machine Model VS-100 III) was used as the device, and cleaning was performed at room temperature with an ultrasonic frequency of 28 kHz, an output of 100 W, and a cleaning time of 3 minutes.

### Resin Compatibility Test (ABS Resin)

A test piece (2×20×100 mm) containing an ABS resin was immersed for 3 minutes at room temperature in the compositions described in Table 2, and then visually observed for the presence or absence of surface changes.
◯: No change
x: Softening

PFH and chlorotrifluoropropene used in the Examples and Comparative Examples are as follows.
PFH
A mixture containing:
93 weight % of perfluoro-3-heptene; and
7 weight % of perfluoro-2-heptene
Chlorotrifluoropropene
HCFO-1233yd
(AMOLEA AS-300 manufactured by AGC Inc.)
HCFO-1233zd
(CELEFIN™ 1233Z manufactured Central Glass Co., Ltd.) Furthermore, oils and resins used in the Examples and Comparative Examples are as follows.
Oils
Polyalkylene glycol (PAG)
SUNICE P 56 manufactured by Japan Sun Oil Company, Ltd.
Polyvinyl ether synthetic base oil (PVE)
(Daphne Perfluoro Oil FV68S manufactured Idemitsu Kosan Co., Ltd.)
Naphthenic mineral oil
(SUNISO 4GS Refrigeration Oil manufactured by Japan Sun Oil Company, Ltd.)
Polyethylene glycol
(PEG-200 manufactured by Sanyo Chemical Industries, Ltd.)
Liquid paraffin
(Liquid paraffin LP No. 70-S manufactured by Sanko Chemical Industry Co., Ltd.)
Resins
ABS resin(SAIKOTEKKU T1101 manufactured Techno-UMF Co., Ltd.)

### Examples 1 to 7 and Comparative Example 1 to 3

The boiling point, surface tension, density, viscosity, and flash point of the compositions of the invention shown in Table 1 as well as the PFH, HCFO-1233yd, and HCFO-1233zd are shown in Table 1. The oil solubility of Examples 1 to 3 are shown in Table 2, and the oil solubility of Examples 4 to 7 are shown in Table 3.

Furthermore, the oil removal rate of Examples 3 and 4 and Comparative Examples 1 to 3 are shown in Table 4. Furthermore, the results of the resin compatibility test of ABS are shown in Table 5.

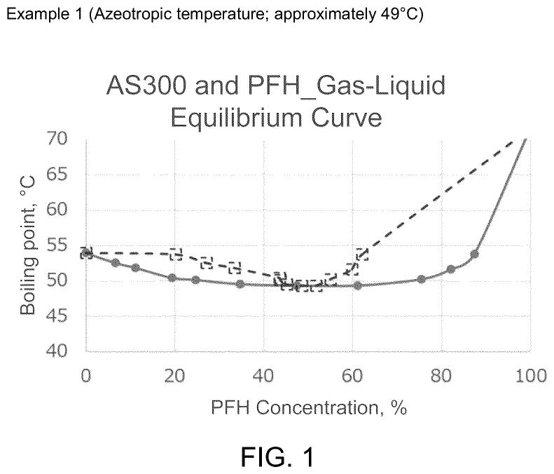

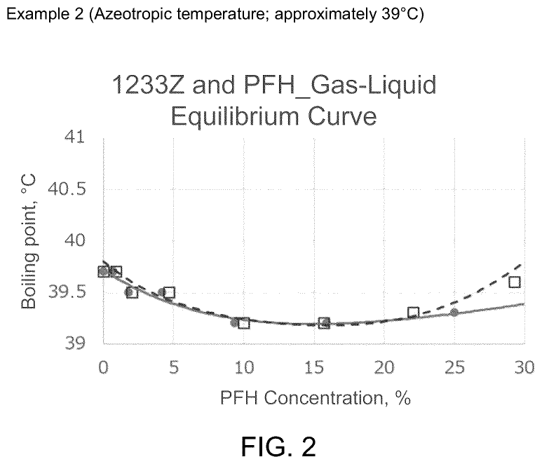

Furthermore, the gas-liquid equilibrium curves of Example 3 and Example 4 are shown in FIG. 1 and FIG. 2.

In FIG. 1, the minimum boiling point was observed at a PFH/HCFO-1233yd mass ratio of approximately 50/50, and in FIG. 2, a minimum boiling point was observed at a PFH/HCFO-1233zd mass ratio of approximately 16/84. Therefore, PFH and chlorotrifluoropropene were confirmed to exhibit an azeotrope-like effect.

As shown in Tables 1 to 5, the compositions of the Examples exhibit excellent oil removal rates and high cleaning power, while also have very low polymer attack properties (solubility).

TABLE 1

| | | | | | | | | Compar- | Compar- | Compar- |
|---|---|---|---|---|---|---|---|---|---|---|
| | | | | | | | | ative | ative | ative |
| | Exam- | Exam- | Exam- | Exam- | Exam- | Exam- | Exam- | Exam- | Exam- | Exam- |
| | ple | ple | ple | ple | ple | ple | ple | ple 1 | ple 1 | ple 1 |
| | 1 | 2 | 3 | 4 | 5 | 6 | 7 | 1 | 2 | 3 |
| Compo- | PFH/ | PFH/ | PFH/ | PFH/ | PFH/ | PFH/ | PFH/ | PFH | 1233yd | 1233zd |
| sition | 1233yd | 1233yd | 1233yd | 1233zd | 1233zd | 1233zd | 1233zd | | | |
| (weight | (30/70) | (40/60) | (50/50) | (16/84) | (30/70) | (40/60) | (50/50) | | | |
| %) | | | | | | | | | | |
| GWP | <10 | <10 | <10 | <10 | <10 | <10 | <10 | <10 | <1 | <1 |
| MW | 161 | 174 | 190 | 145⁾ | 161 | 174 | 190 | 350 | 130.5 | 130.5 |
| Boiling | 50 | 49 | 49 | 39⁾ | 39 | 40 | 41 | 71.5 | 54 | 39 |
| point | | | | | | | | | | |
| (° C.) | | | | | | | | | | |
| Density | 1.455 | 1.478 | 1.501 | 1.353 | 1.392 | 1.422 | 1.453 | 1.632 | 1.39 | 1.31 |
| (g/mL) | | | | | | | | | | |
| Viscosity | 0.59 | 0.61 | 0.62⁾ | 0.428⁾ | 0.45 | 0.47 | 0.49 | 0.77 | 0.57 | 0.41 |
| (Pa/s) | | | | | | | | | | |
| Surface | 20.3 | 19.6 | 18.4 | 18.2⁾ | 17.5 | 17.1 | 16.6 | 13.8 | 21.7 | 18.6 |
| tension | | | | | | | | | | |
| (mN/m) | | | | | | | | | | |
| Flash | None | None | None | None | None | None | None | None | None | None |
| point | | | | | | | | | | |

TABLE 2

| | Example 1 | Example 2 | Example 3 |
|---|---|---|---|
| Composition (weight %) | PFH/1233yd | PFH/1233yd | PFH/1233yd |
| | (30/70) | (40/60) | (50/50) |
| Oil mixture amount (weight %) | 12 | 7 | 3 |
| PAG (SUNICE P56) | | | |
| Oil Solubility | ◯ | ◯ | ◯ |

TABLE 3

| | Example 4 | Example 5 | Example 6 | Example 7 |
|---|---|---|---|---|
| Composition | PFH/1233zd | PFH/1233zd | PFH/1233zd | PFH/1233zd |
| (weight %) | (16/84) | (30/70) | (40/60) | (50/50) |
| Oil mixture | 50 | 36 | 27 | 15 |
| amount | | | | |
| (weight %) | | | | |
| PVE (Daphne | | | | |
| FV68S) | | | | |
| Oil Solubility | ◯ | ◯ | ◯ | ◯ |

TABLE 4

| | | | Comparative | Comparative | Comparative |
|---|---|---|---|---|---|
| | Example 3 | Example 4 | Example 11 | Example 12 | Example 13 |
| Composition | PFH/1233yd | PFH/1233zd | PFH | 1233yd | 1233zd |
| (weight %) | (50/50) | (16/84) | | | |
| Oil Removal | | | | | |
| Rate (%) | | | | | |
| Polyol ester | >99.9 | >99.9 | 89 | >99.9 | >99.9 |
| (SUNISO 4GS) | | | | | |
| Polyethylene | >99.9 | >99.9 | 75 | >99.9 | >99.9 |
| glycol (PEG-200) | | | | | |
| Liquid paraffin | 99.2 | 99.2 | 58 | >99.9 | >99.9 |
| (LP No. 70-S) | | | | | |

TABLE 5

| | | | Comparative | Comparative | Comparative |
|---|---|---|---|---|---|
| | Example 3 | Example 4 | Example 11 | Example 12 | Example 13 |
| Composition (weight %) | PFH/1233yd | PFH/1233zd | PFH | 1233yd | 1233zd |
| | (50/50) | (16/84) | | | |
| Resin Compatibility Test | ◯ | ◯ | ◯ | X | X |
| ABS (after 3 minutes) | | | | | |

1. The composition comprising an azeotropic or azeotropic-like composition containing perfluoroheptene and a chlorotrifluoropropene.

2. The composition according to claim 1 wherein the perfluoroheptene is at least one isomer selected from 1,1,1,2,2,3,4,5,5,6,6,7,7,7-tetradecafluoro-3-heptene, 1,1,1,2,3,4,4,5,5,6,6,7,7,7-tetradecafluoro-2-heptene, and isomers thereof.

3. The composition according to claim 1, wherein the chlorotrifluoropropene is at least one isomer selected from 1-chloro-2,3,3-trifluoropropene, 1-chloro-3,3,3-trifluoro-1-propene, and isomers thereof.

4. The composition according to claim 3, comprising:
10.0 to 75.0 weight % of perfluoroheptene; and
25.0 to 90.0 weight % of 1-chloro-2,3,3-trifluoro-1-propene.

5. The composition according to claim 4, comprising:
20.0 to 75.0 weight % of perfluoroheptene; and
25.0 to 80.0 weight % of 1-chloro-2,3,3-trifluoro-1-propene.

6. The composition according to claim 4, comprising:
45.0 to 55.0 weight % of perfluoroheptene; and
45.0 to 55.0 weight % of 1-chloro-2,3,3-trifluoro-1-propene.

7. The composition according to claim 3, comprising:
5.0 to 30.0 weight % of perfluoroheptene; and
70.0 to 95.0 weight % of 1-chloro-3,3,3-trifluoro-1-propene.

8. The composition according to claim 7, comprising:
10.0 to 20.0 weight % of perfluoroheptene; and
80.0 to 90.0 weight % of 1-chloro-3,3,3-trifluoro-1-propene.

9. A method of removing residue from a surface comprising contacting the surface with a composition comprising an azeotropic or azeotropic-like composition comprising perfluoroheptene and a chlorotrifluoropropene, and recovering the surface from the composition.

10. A method of claim 9, wherein said contacting is accomplished by vapor degreasing.

11. The method of claim 9, wherein said composition further comprises a propellant.

12. The method of claim 11, wherein said propellant is selected from the group consisting of air, nitrogen, carbon dioxide, difluoromethane (CF₂H₂, HFC-32), trifluoromethane (CF₃H, HFC-23), difluoroethane (CHF₂CH₃, HFC-152a), trifluoroethane (CH₃CF₃, HFC-143a; or CHF₂CH₂F, HFC-143), tetrafluoroethane (CF₃CH₂F, HFC-134a; or CF₂HCF₂H, HFC-134), pentafluoroethane (CF₃CF₂H, HFC-125), 1,3,3,3-tetrafluoro-1-propene (HFO-1234ze), 2,3,3,3-tetrafluoro-1-propene (HFO-1234yf), 1,2,3,3,3-pentafluoropropene (HFO-1225ye), 1,1,3,3,3-pentafluoropropene (HFO-1225ze), hydrocarbons, and dimethyl ether.

13. The method of claim 9, wherein said composition further comprises at least one surfactant.

14. A method for depositing a fluorolubricant on a surface comprising:
a. combining a fluorolubricant and a solvent, said solvent comprising an azeotropic or azeotropic-like composition containing perfluoroheptene and a chlorotrifluoropropene,
b. contacting the combination of lubricant-solvent with the surface, and
c. evaporating the solvent from the surface to form a fluorolubricant coating on the surface.

15. The method of claim 14, wherein the surface is that of a semiconductor material, metal, metal oxide, vapor deposited carbon, or glass.

16. The method of claim 15, wherein the surface is that of a magnetic medium.
